(19) United States
(12) Patent Application Publication
(10) Pub. No.: US 2003/0104844 A1
(43) Pub. Date: Jun. 5, 2003

(54) Phone secretarial function extension device for a hand-free set

(75) Inventor: Tonny Chen, Chang-Hua (TW)

Correspondence Address: BRUCE H. TROXELL, SUITE 1404, 5205 LEESBURG PIKE, FALLS CHURCH, VA, 22041, US

(73) Assignee: E-Lead Electronic Co., Ltd.

(21) Appl. No.: 10/004,405

(22) Filed: Dec. 5, 2001

(51) Int. Cl. H04M 1/00

(52) U.S. Cl. 455/569; 455/556; 455/564

(57) ABSTRACT

A phone secretarial function extension device for a hand-free set is particularly related to one that is compatible with all available hand-free sets and cellular phones on markets and is equipped with phone secretarial functions (phone album, voice controlled actuation, voice dialing and recording/playing communication content). It mainly has a wired and wireless remote controller, a receiver and an I/O interface to cooperate with a cellular phone and its associated with hand-free set whereby all kinds of hand-free sets and cellular phones are able to perform extended functions such as a voice controlled dialing operation.

### BACKGROUND OF THE INVENTION

The present invention relates to a phone secretarial function extension device for a hand-free set and particularly to one that is compatible with all available hand-free sets and cellular phones on markets; and it is able to perform phone secretarial functions (phone directory, voice-controlled actuation, voice dialing and recording/playing communication content). It is mainly equipped with a wired and wireless remote controller, a receiver and an I/O interface to cooperate with a cellular phone and its association with a hand-free set whereby all kinds of hand-free sets and cellular phones are able to perform extended functions such as a voice-controlled dialing operation.

Nowadays cellular phones has become so popular and indispensable in modem cities all over the world, they are not simply a communication tool any more, people of all walks of life at different age levels prefer various kinds of cellular phones of their own, having different functions and styles individually. Once a cellular phone is changed, all the peripheral equipment thereof must be replaced or disposed as waste. It is very common for drivers to use cellular phones on vehicles and laws of more and more countries prohibit such a dangerous activity in driving. However, cellular phones having voice-controlled dialing capability are still rare on markets. Drivers using such a kind of cellular phones can be better protected from danger in driving. It is very commonly seen that drivers are forgetful of such prohibition in driving when an emergent calls are coming or must be made, who are forced to pick up a cellular phone or are so absorbed in making a dial, putting them in a fatal jeopardy without notice at all.

To solve such a problem, it is not the intention of the inventor to make all users of cellular phones discard all their old type cellular phones and their peripheral equipment and buy expensive cellular phones equipped with a voice-actuated function. Instead, the inventor comes up with a simple solution by providing a secretarial function extension device which mainly includes a wired or wireless remote controller, a receiver and an I/O interface whereby a cellular phone and a hand-free set can be coupled together to make them have extended secretarial functions without discarding the old peripheral equipment at all.

### SUMMARY OF THE INVENTION

Therefore, the primary object of the present invention is to provide a phone secretarial function extension device which can be coupled to all types of cellular phones and hand-free sets available on markets so as to permit the same to have extended secretarial functions originally not provided.

### BRIEF DESCRIPTION OF THE DRAWINGS

FIG. 1 is a block diagram showing the system of a remote control terminal;

FIG. 2 is a block diagram showing the system of a receiving terminal;

FIG. 3 is a diagram showing the circuit connection of the input and output interfaces;

FIG. 4 is a diagram showing the operation mode of the first embodiment;

FIG. 5 is a diagram showing the operation mode of another embodiment.

### DETAILED DESCRIPTION OF THE PREFERRED EMBODIMENTS

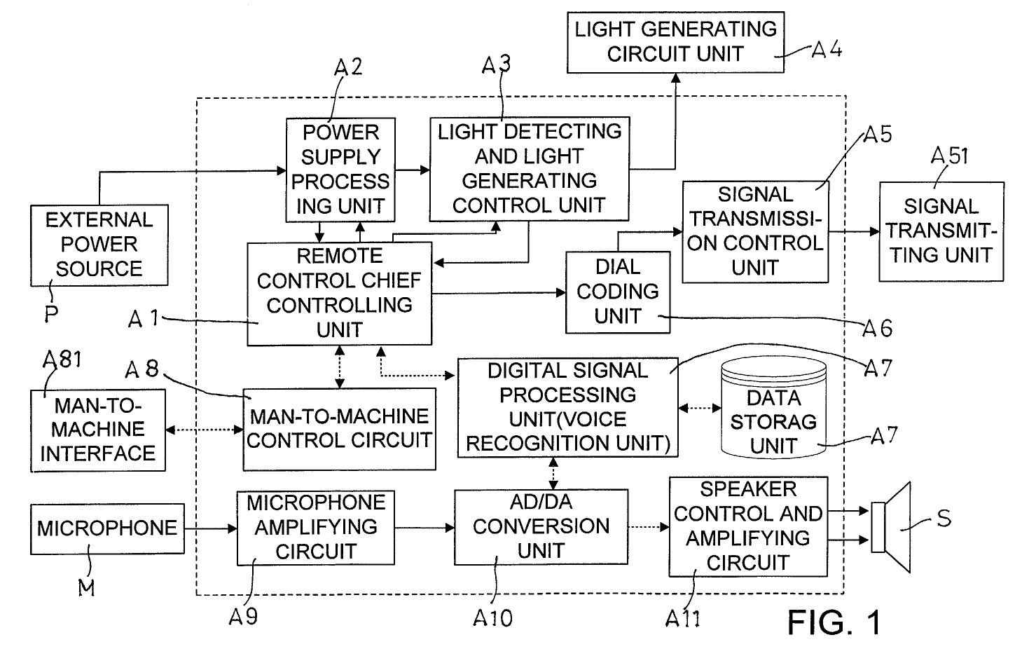

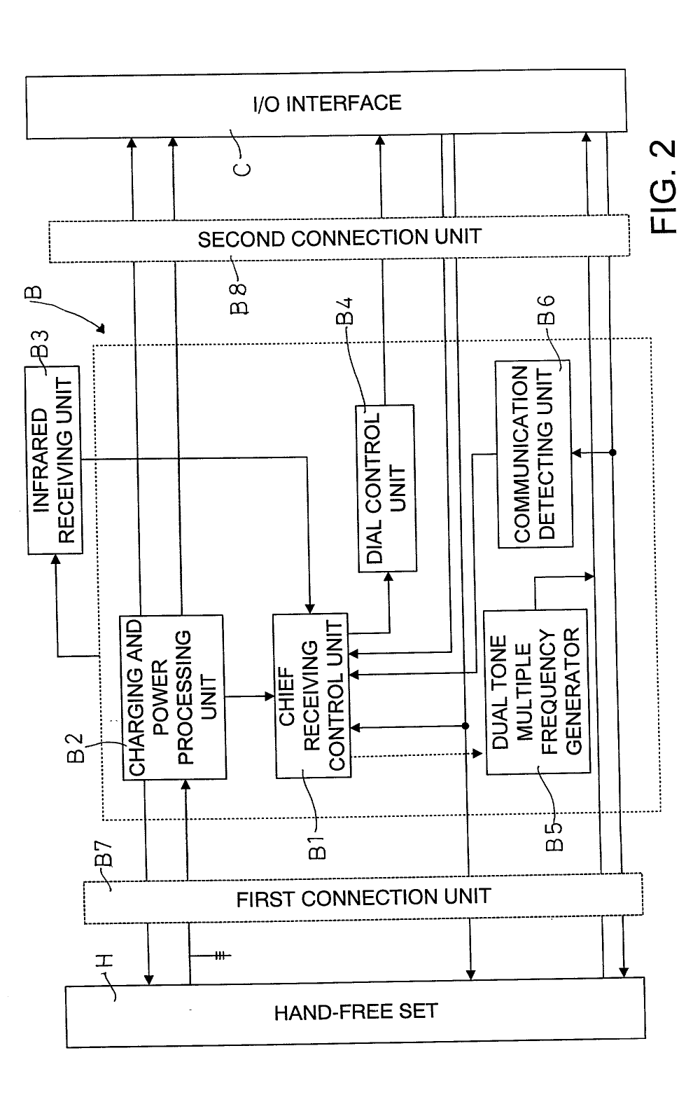

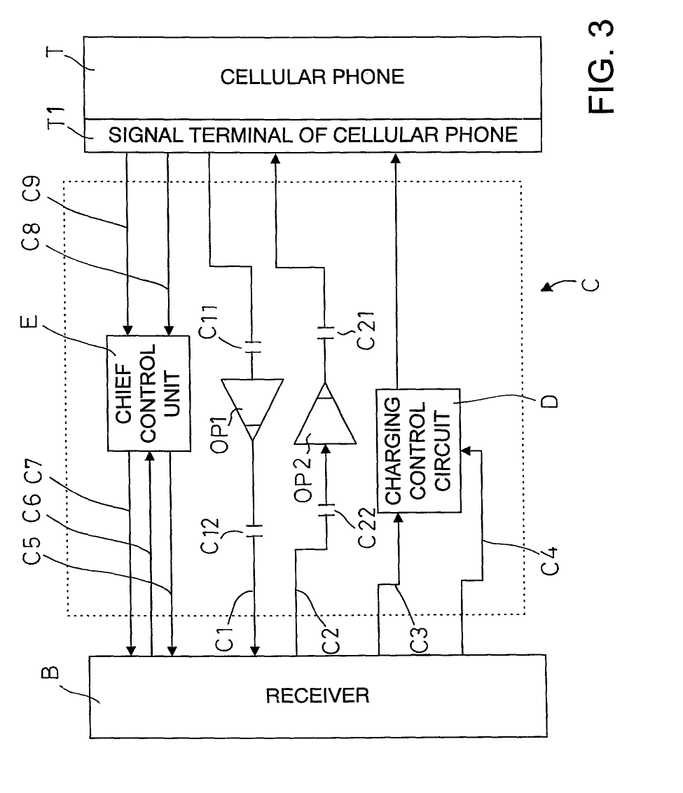

Referring to FIGS. 1, 2 and 3, the systematic block diagram shows that present invention of a phone secretarial function extension device for a hand-free set mainly comprises a wired or wireless remote controller A, a receiver B and an I/O (input/output) interface C that are used to couple to a hand-free set H and a cellular phone T.

The wired or wireless remote controller A is a freely portable unit having an interior in which related remote control circuits are housed, these circuits are actuated to transmit remote control signals therefrom to the receiver B as a number of externally disposed buttons on the remote controller A are pressed.

An end of the receiver B is coupled to a hand-free device H of a cellular phone and the opposite end thereof is connected to a terminal of the I/O interface C. In the receiver B are disposed several remote control signals receiving and processing circuits and a dialing circuit which is remotely actuated by the wired or wireless remote controller A to make a dial operation. One terminal of the I/O interface C is coupled to the receiver B and the other terminal is coupled to a signal terminal T1 of the cellular phone T whereby the receiver B and connection lines of the terminal T1 of the cellular phone are integrally connected by way of the I/O interface C.

The wired or wireless remote controller A comprises a chief remote control unit A1, a power supply processing unit A2, an external power source P, a light detecting and light generating control unit A3, a light generating circuit unit A4, a signal transmission control unit A5, a signal transmitting unit A51, a dial coding unit A6, a digital signal processing unit (a voice identifying unit) A7, an AD/DA conversion unit A10, a data storage unit A71, a man-to-machine interface control circuit A8, a man-to-machine interface A81, a microphone amplifying circuit A9, a microphone M, a speaker control and amplifying circuit A11 and speaker S.

The chief remote control unit A1 is used to chiefly control and coordinate individual components of the wired or wireless controller A to operate accordingly.

The power supply processing unit A2 is coupled to an external power source to raise or lower voltages or adjust the same so as to supply working voltages to individual components of the wired or wireless controller in operation.

The external power source P supplies a working voltage to the wired or wireless controller A.

The light detecting and light generating control unit A3 is subject to the control of the chief remote control unit A1 to direct the operation of the light generating circuit unit A4.

The light generating circuit unit A4 is hidden under a button matrix of a man-to-machine interface A81, or mounted somewhere to an external case of the wired or wireless controller A for a user to make use of the man-to-machine A81 or the wired or wireless controller A to produce light of indication.

The signal transmitting unit A51 converts codes of a dial coding unit into infrared signals and controls a signal transmitting unit A51 to transmit dialing codes of the dial coding unit A6 in an infrared form.

The dial coding unit A6 is subject to the chief remote control unit A1 to get a phone number in the data-storage unit A71 coded and send out the coded phone number by the signal transmission control unit A5 in an infrared form.

The digital signal processing unit (voice identifying unit) A7 processes phonic signals transmitted from an AD/DA conversion unit A10 to identify if the phonic signals are useful or related voice instructions; or processes control signals transmitted from the chief remote control unit A1 to further control the input and output of the AD/DA conversion unit or the input and output of the data storage unit A71; and executes a computer program stored in the data storage unit A71.

The AD/DA conversion unit A10 transforms analog signals from the microphone M into digital ones for the use of the digital signal processing unit (voice identifying unit) A7 and is controlled by the digital signal processing unit (voice identifying unit) A7 to output voice data stored in the data storage unit A71 in phonic sound via speakers S and the speaker control and amplifying circuit A1.

The data storage unit A71 is used for storing a phone directory, corresponding prompts for a man-to-machine interface (numerals from 0 to 9, recording, playing . . . and functional terms of the like), contents of communication, pre-recorded phonic guide of a phone directory, a computer program, and various types of data bases, and temporary storage of the input signals of the man-to-machine interface A81 for batch processing.

The man-to-machine interface control circuit A8 is subject to coordination of the chief remote control unit A1 to direct the operation of a plurality of buttons or the activation of a control operation and to receive signals transmitted from a man-to-machine interface A81 for the use of the chief remote control unit A1 or for setting a wired or wireless remote controller A.

The man-to-machine interface A81 is a pressing button matrix (0-9, SEND, END buttons), turning knob, turn table can be served as an input interface for users to input set-up parameters, such an interface has buttons including numeral from 0-9,*, #, record, play, new augment, correction, end, SEND . . . ;

The microphone amplifying circuit A9 is used to process phonic signals transmitted from a microphone by amplifying the same or other compensating operations of loss of fidelity;

The microphone M is adapted for inputting phonic instructions;

The speaker control and amplifying circuit A11 is subject to the control of the AD/DA conversion unit to process voice signals and output the same via a speaker S.

The speaker S is used for outputting voice signals.

A receiver B comprises a chief receiving control unit B1, a charging and power processing unit B2, an infrared receiving unit B3, a dial controlling unit B4, a dual tone multiple frequency generator (DTMF) B5, a communication detecting unit B6, a first and second connection unit B7, B8.

The chief receiving control unit B1 is used to dominate and coordinate operations of all units of the receiver B.

The charging and power processing unit B2 operates in cooperation with a power input and charging control of a hand-free device H to output corresponding electric voltage and a charging control signal to said I/O interface C.

The infrared receiving unit B3 receives infrared signals transmitted from the signal transmitting unit A51 housed inside of the wired or wireless controller A and decodes the same for the use of a rear end of the chief receiving control unit B1 (the infrared receiving unit B3 can be simply a receiver of infrared signals and the decoding operation can be performed by a unit at a rear end).

The dial controlling unit B4 subject to the control of the chief receiving control unit B1 outputs dialing signals to put a cellular phone T in a dialing status.

The dual tone multiple frequency generator (DTMF) B5 subject to the control of the chief receiving control unit B1 generates acoustic frequency control signals for dialing, ( standing for keys, such as 0-9, *, #, . . . and etc.), to substitute the extension numbers after the cellular phone T is dialed and successfully connected by using the input dialing keys thereof.

The communication detecting unit B6 receives communication signals of the I/O interface C and outputs signals to the chief receiving control unit B1 to make the same aware of a current status of a cellular phone T.

The first connection unit B7 can be a plugging hole or a flexible signal cord for connection to a hand-free device H, it usually is a coupling socket or connection cord of a hand-free device H for use in connection to a cellular phone T whereby signals of the receiver B can be transmitted to the hand-free device H by means of the first connection unit B7 or signals of the hand-free device H can be input into the receiver B by the first connection unit B7.

The second connection unit B8 can be a plugging hole or a flexible signal cord for connection of the receiver B to the I/O interface C so as to permit signals to be transmitted between the receiver and the I/O interface C; moreover, the second connection unit B8 is removed and respective signal cords of the I/O interface are directly coupled to the corresponding lines of the receiver B.

The I/O interface C adapted for conversion of the input and output signals of the cellular phones T of various types and produced by different manufactures permits the transformed signals to be compatible with the present invention or the respective cellular phones. The I/O interface C is a signal cable connected to a cellular phone; and the I/O interface C is a plurality of electronic lines coupled to the receiver B and a signal terminal of the cellular phone T.

The electronic lines comprises a voice signal output line C1, a voice signal input line C2, a charging line C3, a charging control line C4, a dialing control line C5, a common dialing signal line C6, a flagpole control line C7, a cellular phone working time pulse input line C8, cellular phone analog signal input line C9.

The voice signal output line C1 has one end input via the receiver B and is coupled at the other end to an output end of the signal terminal T1 of a cellular phone is serially connected to an amplifier OP1 and a capacitor C11 (or resistor).

The voice signal input line C2 has one end output via the receiver B and the opposite end is coupled to an input end of the signal terminal T1 of a cellular phone is provided with a serially connected amplifier OP2 and a capacitor C21 ( or a resistor).

The charging line C3 has one end coupled to the receiver B at one end and is connected to a charging end of the signal terminal T1 of a cellular phone is equipped with a charging control circuit D to control the activation and output voltages of the charging line.

The charging control line C4 adapted for the input of signals of the charging and power processing unit B2 to control the operation of the charging control circuit D which can outputs various electric voltages in conformance to the type of a cellular phone T in connection according to the signals of the charging control line.

The dialing control line C5 employed to transmit signals of the dialing control unit controls the I/O interface chief control unit;

The common dialing signal line C6 used to transmit signals of the dialing unit is connected to the dial control unit B4 at one end and to the chief control unit E of the I/O interface C at another end.

The flagpole control line C7 is employed to transmit flagpole signals to the receiver B to inform if the I/O interface C has been in connection to a cellular phone T or not.

A cellular phone working synchronic signal input line C8 is used to transmit the working synchronic signals of the cellular phone T so as to permit the receiver B to be in synchronic operation with the cellular phone T; such a synchronic signal input line C8 has one end coupled to the cellular phone and the other end connected to the chief control unit E of the I/O interface C.

A cellular phone analog signal input line C9 is used to transmit from the chief control unit the dialing and control digital data input into and output from the cellular phone.

The chief control unit E transmits various digital signal codes of the control and dialing signals via the signal input line C9 to the cellular phone and receives and processes various signals from the receiver B.

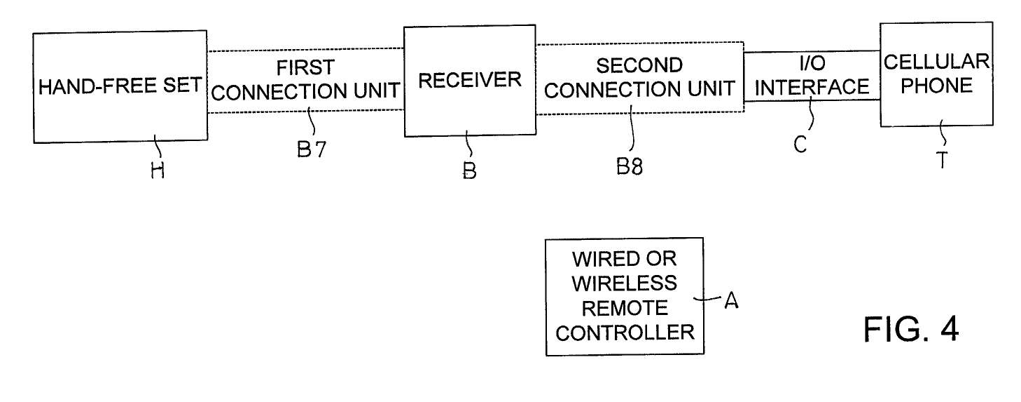

Referring to FIG. 4, the diagram shows the practical embodiment of the present invention. A user connects the first connection unit B7 of the receiver B to the hand-free device H, and the other end is coupled to one end of the I/O interface C by the second connection unit B8, and the other end of the I/O interface C is connected to the signal terminal T1 of the cellular phone T to obtain the extension device of the hand-free device H.

The operation mode of the present invention is given as below:

▪ Dialing a Cellular Phone T by Way of a Wired or Wireless Remote Controller A:

A user can make a dial directly on the man-to-machine interface A81 in a common phone dialing operation by way of the wired or wireless remote controller A which can generate feed-back sound by a speaker S of its own. When a user press down the SEND key of the man-to-machine interface A81, the dialing signals are transmitted by way of the signal transmitting unit A51 in the form of infrared to the receiver B and the receiver B is instructed to make a dial. If the user keys in an extension number by means of the man-to-machine A81 after making the dial(# can be input as a division mark and then an extension number is added thereto), then the receiver B is made to send out the extension number too, effecting the dialing of the extension number accordingly.

The proceeding dialing operation of a cellular phone by way of a wired or wireless remote controller includes the following steps:

1.Key in the phone number to be dialed by way of the man-to-machine interface A81.

2.The man-to-machine control circuit A8 receivers the signals of the man-to-machine interface A81 that are transmitted to the chief remote control unit A1.

3. The chief remote control unit A1 judges if the signals are simply dialing signals or control signals whose operation mode will be disclosed hereinafter. If they are simply the dialing signals, digital signal processing unit (voice identifying unit) A7 is instructed to process the signals and search for and pick out the key related voice stored in the data storage unit A71.

4.The digital signal processing unit (voice identifying unit) A7 will get the fed back voice through the AD/DA conversion unit A10 and the speaker control and amplifying circuit All broadcast via the speaker S. For instance, the numeral 6 key is pressed down, the feedback voice will be the sound of number 6.

5.The data storage unit A71 temporarily keeps the phone numbers input by the man-to-machine interface A81 in memory until the user press the SEND button and the chief remote control unit A1 will take out in batch all the input data from the data storage unit A71 and code the same by the dial coding unit A6, and then the to-be-dialed phone number is transmitted in an infrared form to a receiver by way of the signal transmission control unit A5 and signal transmitting unit A51.

6. The infrared receiving unit B3 of the receiver B receives the infrared signals transmitted from the wired or wireless remote controller A and gets the same decoded and transmits them to the chief receiving control unit B1 which outputs in turn the signals to the dial control unit B4. The dial control unit B4 receives all the output data and sends out the same thereafter.

7. After the dial control unit B4 receives the dialing signals from the chief receiving control unit B1, a signal is delivered to the I/O interface C to make the cellular phone T activated by means of the dialing signal line C6 in a to-be-dialed status.

8. The dual tone multiple frequency generator DTMF B5 produces corresponding voice frequency codes according to the received phone numbers transmitted from the chief receiving control unit B1 and the codes are delivered to the cellular phone T via the voice input signal line C2 so as to permit the cellular phone to dial an extension number after a call is connected.

▪ Capability to Compile a Phone Directory:

A user can make use of the associates' phone numbers stored in the data storage unit B71 of the wired or wireless remote controller B, in a principle of one man one phone number manner or other proper forms. The user utilizes a man-to-machine interface to activate the pre-recorded phone directory compiling voice guidance of the data storage unit B71 to help the user compile his or her own electronic directory.

The operational flow of compiling a phone directory by using the wired or wireless remote controller is given as below:

1. A user employs the man-to-machine interface A81 to start the phone directory function of the data storage unit A71.

2. After the phone directory function is started, the system reads out in a stepwise manner the voices, such as:

1. Setting up a phone directory;

2. Making amendment on the phone directory; and

3. Conducting searches, and etc; to help a user make a selection of required functions on the numerical keys of the man-to-machine interface.

3. The user can choose the functions to be carried out by way of the man-to-machine interface A81.

▪ Voice Operated Dialing Function:

A user actuates the voice dialing function by means of the man-to-machine interface A81 which supplies the names of people in response the voice guidance, and the system identifies and feeds back the names in voice for confirmation. After the user makes the confirmation, the wired or wireless remote controller A will output infrared signals to instruct the receiver B to dial the cellular phone T.

The operational flow of the voice actuated dialing is given below:

1. A user makes use of the man-to-machine interface A81 to start the voice dialing function, for instance, the user press down SEND key as a start of the voice dialing function, the system will output a voice prompt to instruct the user speaks out the name.

2. After the completion of the identification, the digital signal processing unit (voice identifying unit) A7 will search for the corresponding phone number in the phone directory of the data storage unit A71 and echo the name of the person registered with the phone number for confirmation.

3. After the user confirms, the wired or wireless remote controller A will transmit the phone number corresponding to the name in infrared signals to the receiver B.

4. The receiver B takes the phone number and makes dial on the cellular phone T.

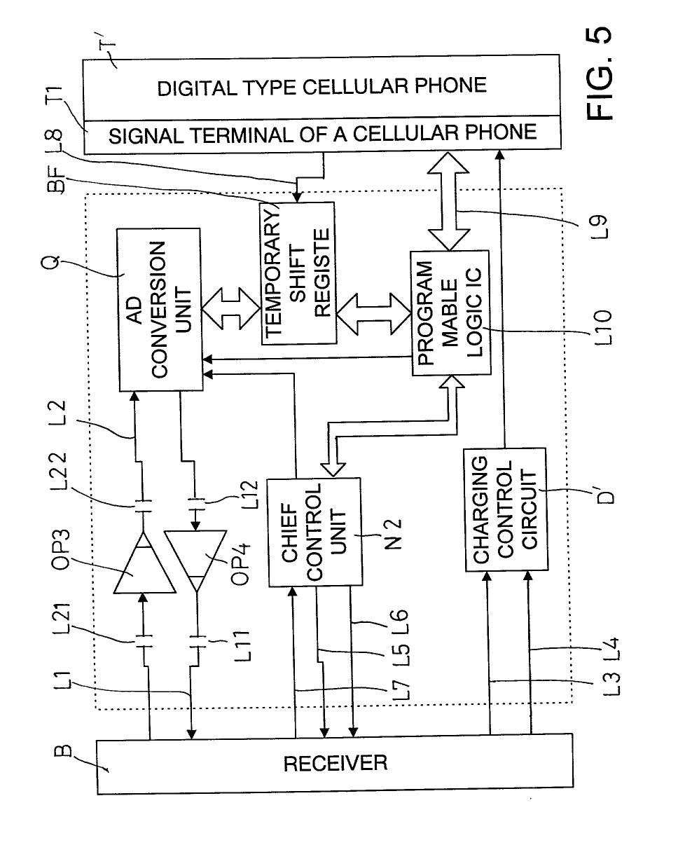

The I/O interface C described above is adaptable for use in common cellular phones T operated in analog type signals; in case of a cellular phone T operated in digital signals, as shown in FIG. 5, then the I/O interface L of the present invention is made up of a voice signal output line L1, a voice signal input line L2, a charging line L3, a charging control line L4, a dialing control line L5, a common dialing signal line L6, a flagpole control line L7, a cellular phone signal input line L9, a programmable logic IC L10, a shift temporary register BF, an AD conversion unit Q, a shift control line L8; wherein:

The voice signal output line L1 having one end input via a receiving system B′ and coupled to an output of a signal terminal of a cellular phone T′ is serially connected to an amplifier OP3 and a capacitor L11 (or resistor).

The voice signal input line L2 having one end output via a receiving system and the opposite end coupled to an input of a signal terminal T1′ of a cellular phone T′ is provided with a serially connected amplifier OP4 and a capacitor L21′( or a resistor);

The charging line L3 having one end coupled to the receiving system B′ at one end and connected to a charging end of the signal terminal T1′of a cellular phone T′ is equipped with a charging control circuit D′ to control the activation and output voltages of the charging line.

The charging control line L4 having one end coupled to said receiver and the opposite end connected to a charging terminal of a signal terminal of a cellular phone is provided with a charging control circuit thereon to control the activation of said charging line and output charging voltages thereof.

The dialing control line L5 employed to transmit signals of said dialing control unit controls the I/O interface chief control unit N2.

The common dialing signal line L6 for transmitting signals of the dialing unit is connected to the dialing unit at one end and to the chief control unit N2 of the I/O interface at another end.

The flagpole control line L7 is employed to transmit flagpole signals to the chief control unit to indicate if said I/O interface has been in connection to a cellular phone T′ or not.

The cellular phone signal input line L9 is employed to transmit control signals of a cellular phone and said I/O chief control unit N2 and input/output signals of communication with a programmable logic IC L10 disposed thereon.

The chief control unit N2 is activated by signals transmitted from the signal input line L9 of the cellular phone T′ and transmits a control signal indicating if the I/O interface is operating or not to a rear terminal of a receiving system.

The programmable logic IC L10 is used to get input and output data coded.

The shift temporary register BF is employed to store coded data in the programmable logic IC L10 and the AD conversion unit Q.

The AD conversion unit Q is used for converting input signals (digital signals into analog signals and analog signals into digital signals) into signal mode available at rear terminals.

The shift control line L8 is used for a cellular phone T′ to input control signals.

The proceeding embodiment is provided only for illustration purpose and does not intend to limit its scope. Any equivalent modifications, variations and alternations according to the following claims are all regarded to fall into the claimed scope of the present invention.

I claim:

1. A phone secretarial function extension device for a hand-free set comprising a wired or wireless remote controller, a receiver and an I/O (input/output) interface that are used to couple a hand-free set to a cellular phone;
wherein said wired or wireless remote controller is a freely portable unit having an interior in which remote control circuits are housed, said circuits are actuated to transmit remote control signals therefrom to said receiver as externally disposed buttons on said remote controller are pressed; an end of said receiver is coupled to said hand free set of a cellular phone and the opposite end thereof is connected to a terminal of said I/O interface; in said receiver are disposed remote control signals receiving and processing circuits and a dialing circuit that are remotely actuated by said wired or wireless remote control to make a dial; one terminal of said I/O interface is coupled to said receiver and the other terminal is coupled to a signal terminal of said cellular phone whereby said receiver and a plurality of connection lines of said terminal of said cellular phone are integrally connected by way of said I/O interface.

2. The phone secretarial function extension device for a hand-free set as claimed in claim 1 wherein said wired or wireless remote controller comprises:
a chief remote control unit being used to chiefly control and coordinate individual components of said wired or wireless controller to operate;
a power supply processing unit being coupled to an external power source to raise or lower the voltage thereof or adjust the same so as to supply working voltages to individual components of said wired or wireless controller in operation;
said external power source supplying a working voltage to said wired or wireless controller;
a light detecting and light transmitting control unit being subject to the control of said chief remote control unit to direct operation of a light generating circuit;
said light generating circuit being hidden under a button matrix of a man-to-machine interface, or mounted somewhere to an external case of said wired or wireless controller to produce light of indication;
a signal transmission control unit converting codes of a dial coding unit into infrared signals and controlling a signal emitting unit to transmit dialing codes of said dial coding unit in an infrared form;
a signal transmitting unit of an infrared generator being subject to the control of said signal transmission control unit to transmit phone numbers converted into coded signals by said dial coding unit in an infrared form;
said dial coding unit being subject to the control of said chief remote control unit to get a phone number in said data storage unit coded and send out the coded phone number by said signal transmitting unit in an infrared form;
a digital signal processing unit (voice identifying unit) processing signals transmitted from an AD/DA conversion unit to identify if said signals are useful or related voice instructions; or processing control signals transmitted from said AD/DA conversion unit and said chief remote control unit to further control input and output of said AD/DA conversion unit or input and output of said data storage unit;
said AD/DA conversion unit transforming analog signals from a microphone into digital ones for the use of said digital signal processing unit (voice identifying unit) and being controlled by said digital signal processing unit (voice identifying unit) to output voice data stored in a data storage unit in phonic sound via speakers or corresponding circuit;
said data storage unit being used for storing a phone directory, corresponding prompts for a man-to-machine interface(0-9, recording, playing . . . and functional terms of the like), contents of communication, pre-recorded phonic guidance of said phone directory and various data bases, and also for temporary storing signals of said man-to-machine interface for batch processing;
a man-to-machine interface control circuit being subject to coordination of said chief remote control unit to direct the operation of a plurality of buttons or the activation of a control operation and to receive signals transmitted from a man-to-machine interface for the use of said chief remote control unit or for setting a wired or wireless remote controller;
said man-to-machine interface being a pressing button matrix including buttons, (such as digits of 0-9,*, #, recording, playing, augment, correction, end, SEND), a turning knob, a turn table for a user to input setting parameters;
a microphone amplifying circuit being used to process phonic signals transmitted from a microphone by amplifying the same or other operations on compensating loss of fidelity;
a microphone for inputting phonic instructions;
a speaker control and amplifying circuit being subject to the control of said AD/DA conversion unit to process voice signals and output the same via a speaker;
said speaker being used for outputting voice signals;

3. The phone secretarial function extension device for a hand-free set as claimed in claim 1 wherein said receiver comprises:
a chief receiving control unit being used to dominate and coordinate operations of all units of said receiver;
a charging and power processing unit operating in cooperation with a power input and charging control of a hand-free set to output corresponding electric voltage and a charging control signal to said I/O interface;
an infrared receiving unit receiving infrared signals transmitted from said signal transmitting unit housed inside of said wired or wireless remote controller and decoding the same for the use of said rear connected chief receiving control unit (said infrared receiving unit being also used only for receiving infrared signals and decoding the same for the use of a rear end);
wired or wireless controller and decoding the same for the use of a rear end of said chief receiving control unit (said infrared receiving unit can be simply a receiver of infrared signals and said decoding operation can be performed by a rear end unit);
a dual tone multiple frequency generator (DTMF) being subject to control of said chief receiving control unit to generate acoustic frequency control signals for dialing, (standing for keys, such as 0-9, *, #, . . . and etc.), to substitute input phone numbers transmitted via a dialing keys of a cellular phone;
a communication detecting unit receiving communication signals of said I/O interface and outputting signals to said chief receiving control unit to make the same aware of a current status of a cellular phone;
a first connection unit being a plugging hole or a flexible signal cord for connection to a hand-free device, it usually being a coupling socket or connection cord of said hand-free set for use in connection to a cellular phone whereby signals of said receiver can be transmitted to said hand-free set by said first connection unit or signals of said hand-free device can be input to said receiver by said first connection unit;
a second connection unit being a plugging hole or a flexible signal cord for connection of said receiver to said I/O interface so as to permit signals to be transmitted between said receiver and said I/O interface; moreover, said second connection unit being removed and respective signal cords of said I/O interface being directly coupled to corresponding lines of said receiver.

4. The phone secretarial function extension device for a hand-free set as claimed in claim 1 wherein said I/O interface comprises:
a voice signal output line having one end output from said receiver and the other end thereof coupled to an input end of a signal terminal of a cellular phone, with a compatible amplifier and a capacitor ( or resistor) serially connected thereto;
a voice signal input line having one end output via a receiving system and the opposite end coupled to an input terminal of a signal terminal of a cellular phone being provided with a serially connected compatible amplifier and a capacitor( or a resistor);
a charging line having one end coupled to said receiver at one end and connected to a charging terminal of a signal terminal of a cellular phone being equipped with a charging control circuit to control the activation and output voltages of said charging line;
a charging control line having one end coupled to said receiver and the opposite end connected to a charging terminal of a signal terminal of a cellular phone being provided with a charging control circuit thereon to control the activation of said charging line and output charging voltages thereof;
a dialing control line employed to transmit signals of said dialing control unit controlling said I/O interface chief-control unit;
a common dialing signal line for transmitting signals of said dialing unit being connected to said dialing unit at one end and to an I/O interface chief control unit at another end;
a flagpole control line being employed to transmit flagpole signals to a multiplexer control unit to indicate if said I/O interface has been in connection to a cellular phone or not;
a cellular phone working synchronic signal input line used to transmit working synchronic signals of a cellular phone so as to permit said receiver to be in synchronic operation with said cellular phone; such a synchronic signal input line having one end coupled to said cellular phone and the other end connected to a chief control unit of said I/O interface;
a cellular phone analog signal input line being used to transmit from a chief control unit dialing and control digital data input into and output from said cellular phone;
said chief control unit transmitting various digital signal codes of control and dialing signals via said signal input line to said cellular phone and receiving and processing various signals from said receiver.

5. The phone secretarial function extension device for a hand-free set as claimed in claim 1 wherein said I/O interface comprises:
a voice signal output line having one end input via a receiving system and coupled to an output terminal of a signal of a cellular phone is serially connected to an amplifier and a capacitor ( or resistor);
a voice signal input line having one end output via a receiving system and the opposite end coupled to an input terminal of a signal terminal of a cellular phone is provided with a serially connected amplifier and a capacitor( or a resistor);
a charging line having one end coupled to a receiving system at one end and connected to a charging terminal of a signal terminal of a cellular phone is equipped with a charging control circuit to control the activation and output voltages of said charging line;
a charging control line having one end coupled to said receiver and the opposite end connected to a charging terminal of a signal terminal of a cellular phone is provided with a charging control circuit thereon to control the activation of said charging line and output charging voltages thereof;
a dialing control line employed to transmit signals of said dialing control unit controls said I/O interface chief control unit;
a common dialing signal line for transmitting signals of said dialing unit being connected to said dialing unit at one end and to an I/O interface chief control unit at another end;
a flagpole control line being employed to transmit flagpole signals to said multiplexer control unit to indicate if said I/O interface has been in connection to a cellular phone or not;
a cellular phone signal input line being employed to transmit control signals of a cellular phone and said I/O chief control unit and input/output signals of communication; and a programmable logic IC is disposed thereon;
said chief control unit being activated by signals transmitted from said cellular phone signal input line and transmitting a control signal indicating if said I/O interface is operating or not to a rear terminal of a receiving system;
a programmable logic IC being used to get input and output data coded;
a shift temporary register being employed to store coded data in said programmable logic IC and a conversion unit;
an AD conversion unit being used for converting input signals (digital signals into analog signals and analog signals into digital signals) into signal mode available at rear terminals;
a shift control line being used for a cellular phone to input control signals.
